(19) United States
(12) Patent Application Publication
(10) Pub. No.: US 2026/0029997 A1
(43) Pub. Date: Jan. 29, 2026

(54) DECENTRALIZED ARCHITECTURE USING ARTIFICIAL INTELLIGENCE DRIVEN AUTONOMOUS SELF-HEALING OF DISTRIBUTED SOFTWARE

(71) Applicant: AMERICAN EXPRESS TRAVEL RELATED SERVICES COMPANY, INC., New York, NY (US)

(72) Inventors: Andras L. FERENCZI, Scottsdale, AZ (US); Pedro Burglin PAES, Peoria, AZ (US); Alaric M. EBY, Austin, TX (US); Aniesh CHAWLA, Phoenix, AZ (US); Nithin Kumar Ullal KULAPURAM, Phoenix, AZ (US); Joseph GYAWALI, Austin, TX (US)

(73) Assignee: AMERICAN EXPRESS TRAVEL RELATED SERVICES COMPANY, INC., New York, NY (US)

(21) Appl. No.: 18/784,509

(22) Filed: Jul. 25, 2024

(51) Int. Cl. G06F 8/35

(52) U.S. Cl. CPC G06F 8/35

(57) ABSTRACT

Disclosed herein are system, method, and computer program product embodiments for autonomously repairing software by leveraging a large language model (LLM). A control system may detect a first error associated with an application executing in a region. The control system may then repair the first error associated with the application by: identifying a source of the first error within the application; generating a solution by inputting the source of the first error to an LLM; and implementing the solution via the LLM. The control system may then determine that the application is repaired by: executing the application; generating an output; and comparing the output to a predefined value. The control system may then deploy the application in the region.

### BACKGROUND

### Field

This field is generally related to increasing data security using artificial intelligence (AI) to perform self-healing on software systems.

### Related Art

Computer software (e.g., applications, services) encounter various types of errors. These errors may exist in syntax, and prevent the application from compiling or executing. Applications may also include logic errors, where the application executes but its behavior deviates from the intended function. For example, a function may input two variables, A and B, perform an operation, and return variable A. However, a logic error may exist where the function returns variable B instead. Here, the program may compile and execute, but the incorrect result is returned.

Software error effects are often compounded in enterprise environments where multiple applications or services are deployed. Oftentimes, an application may leverage a separate application to provide a specific function. For example, an email service may query an identity service to authenticate login credentials. This architecture allows an enterprise environment to utilize lightweight applications, where each application is designed around a set of core functionalities. However, when one or more of these applications fails, the failure may not only affect the failed application, it may also prevent other applications from functioning properly. Using the example above, if the identify service fails, the email application may not function properly.

These errors may further affect the machines running the applications. For example, a server may be deployed in an enterprise environment and execute multiple applications. One of the applications may experience an error and subsequently enter a failure state. For example, the error may cause the application to use all or nearly all of the server's resources (e.g., CPU, RAM, disk usage), thereby preventing the other applications from functioning. As a result of the single failure, the entire server may be severely impacted.

Additionally, enterprise systems often deploy the same version of an application across different environments or regions, based on physical or logical boundaries. For example, the same version of an email service may be deployed on two physically separate networks. Additionally, two instances of the same email eservice may be deployed on the same network, where one instance is reserved for internal enterprise employees, and the second instance is reserved for external customers. In both cases, an error in the email service may negatively impact both networks, sets of users, and the machines running the applications. It may not only be difficult to detect the errors occurring in both environments, it may also be difficult to manage updating the application.

### BRIEF SUMMARY

Disclosed herein are system, apparatus, device, method and/or computer program product embodiments, and/or combinations and sub-combinations thereof, for increasing computer functionality and performance by using artificial intelligence (AI) to detect and repair software errors. This disclosure describes a control system that identifies, fixes, tests, and deploys software repairs. The control system may leverage a machine learning model, such as a large language model (LLM), to repair software errors. The control system may then verify the error has been fixed, and deploy the application within the environment.

### BRIEF DESCRIPTION OF THE DRAWINGS

The accompanying drawings are incorporated herein and form a part of the specification.

FIG. 1A depicts a block diagram of an enterprise environment, according to some embodiments.

FIG. 1B depicts a block diagram of a client device with an integrated control system, according to some embodiments.

FIG. 2 depicts a block diagram of an application, according to some embodiments.

FIG. 3 depicts a block diagram of a repair system, according to some embodiments.

FIG. 4 depicts a flowchart illustrating a method for using artificial intelligence (AI) to perform self-healing on software systems, according to some embodiments.

FIG. 5 depicts a flowchart illustrating a method for using an LLM to fix a software error, according to some embodiments.

FIG. 6 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for increasing computer functionality and performance by using artificial intelligence to detect and repair software errors. A distributed control system may be leveraged to perform the detection and repair process. The control system may detect errors at deployed (e.g., executing) applications. The control system may be further configured to detect errors in applications before deployment. For example, the control system may analyze source code for an application that has been staged for testing, or within an integrated development environment (IDE) on a computing device. Upon detecting an error, the control system may utilize a machine learning model, such as a large language model (LLM), to generate and implement a solution. The control system may then deploy the updated software. For applications not yet operating in the environment, the control system may deploy and execute the application. For applications that were executing when the error was detected, the control system may re-install or re-deploy an updated version within the environment.

Current systems may identify errors by detecting that an application has crashed or is unresponsive. Diagnosing and repairing the error may require extensive manual efforts by an engineering team. In addition to disabling the application itself, the error may also impact the physical machine where the application is executing. Thus, the machine and any other applications it was running may have to be disabled while the error is resolved.

An application may write logs to a file while executing. Current systems may attempt to detect errors by using regular expressions to identify errors in log files. However, regular expressions lack nuance because they are static. Thus, if a new error is written to a log and the regular expression fails to identify it, the error may go undetected. Additionally, the regular expression has to be updated to include the new error type. For example, a regular expression may be configured to search a log file for failure to establish an internet connection, but not be configured to search for errors related to expired credentials. Thus, when an error related to expired credentials arises, the regular expression is unable to identify it. Additionally, these systems lack an ability to automatically repair the error and deploy an updated version of the application. Instead, these system requires manual intervention, such as by a software engineer.

Certain errors, such as logic errors, may be difficult to detect during development, because the application may compile, deploy, and execute, but the logic error causes it to perform an undesirable behavior. These errors may not be diagnosed until execution, when the desired output is missing. Thus, there is a need to identify and fix these errors before deployment, while minimizing application and machine down time.

To address such issues, the control system described herein leverages AI, specifically machine learning models, to detect errors, dynamically generate solutions, and deploy the solutions.

The control system may be configured to detect a multitude of errors. In some embodiments, an error may be related to the syntax within an application's source code. The syntax error may prevent the application from compiling, or for an interpreted language, prevent its execution. For example, a syntax error may occur when an application written in C is missing a semicolon.

In some embodiments, a source code error may be related to the logic of an application. A logic error may prevent the application from executing as originally designed. For example, a logic error may occur when a variable, meant to be set by user input, instead uses hardcoded (e.g., predefined) value. Thus, although the application may compile and execute, the logic error causes the hardcoded value, instead of the user input value, to be used. Here, the control system may interpret the source code, and recognize that the variable set by user input is never used.

The control system may be further configured to detect errors associated with the application's configuration (e.g., settings). For example, an application may include a configuration file defining various settings associated with the application. For example, the configuration file may define resource file paths referenced by the application, libraries used and referenced, and settings for application logging. An error may occur if a required settings value is missing or is incorrect. For example, a configuration file may include a file path to a resource (e.g., an image, log file location). However, an error may occur if the file path does not exist or cannot be reached.

The control system may further detect an error based on determining that an application has stopped functioning. The control system may determine this by querying an operating system to determine what processes are currently running. For example, an application monitored by the control system may have crashed, and the operating system may indicate that the process is no longer executing.

In some embodiments, the control system may detect an error based on telemetry values. Telemetry values may include any measurable data associated with an application and physical resource usage such as: CPU, memory, disk, and network usage. The control system may use a machine learning model to identify changes and trends in these telemetry values to infer a state of the application. For example, an application that is functioning properly may typically use 1% CPU and 10% RAM (e.g., 100 MB). The application may further write to the machine's disk at 0.1 MB/s. In an error state, for example, application telemetry values may increase to 10% CPU and 90% RAM usage, and 10 MB/s disk utilization. Based on these values, control system may predict that the application has encountered an error state.

In some embodiments, the control system may detect an error unrelated to the application itself (e.g., a syntax error), but instead one associated with a third-party system. The error may be a result of failed communications with the third-party system or a failure of the third-party system itself. For example, an application may use https to encrypt communications. The application may have a security certificate to verify its integrity and enable https. However, the security certificate may have an expiration date, at which point it should be updated or refreshed. Here, the control system identify a failure to use https, and may predict that the error is associated with the expired SSL certificate.

Once an error is detected, the control system may use a machine learning model to predict a solution. The solution may be designed to fix the error. For example, if the error is associated with source code (e.g., syntax error, logic error), the machine learning model may predict new source code to fix the error. Here, the machine learning model may generate new source code to replace the code causing the error. When the error is related to a configuration or settings field, the machine learning model may predict that a new configuration or settings field is required. For example, the machine learning model may replace a nonexistent resource path with one that exists on the machine where the application is deployed. When the error relates to a third-party system (e.g., an expired SSL certificate) the predicted solution may involve communications with the third-party. For example, the machine learning model may predict and cause the control system to access an API at the third-party to update to retrieve a new SSL certificate.

In some embodiments, multiple solutions may be predicted. Here, each solution may be assigned a probability associated with the model's confidence that the solution will fix the error. The control system may be configured to implement the solution with the highest probability. In some embodiments, the control system may use a threshold to determine whether to employ a solution. For example, the control system may implement a solution with an associated confidence score greater than or equal to 80%. This may be beneficial to ensure that effective solutions are used.

As will be discussed below, the control system may be configured to test solutions. For example, the control system may utilize one or more unit tests associated with the application to ensure that: (1) the error has been fixed; and (2) no additional errors have been introduced. The control system may be further configured to stage and/or deploy the updated application. For example, the control system may stage an updated version of the application on the network for further inspection. In some embodiments, the control system may terminate instances of the old application and execute instances of the updated application.

The control system may further be configured to generate and send alerts to other devices on a network. The control system may generate and send alerts in response to any of: (1) detecting an error at an application; (2) predicting a solution to fix the error; (3) solution testing results; (4) staging the solution for further inspection; and (5) deploying the fixed application. In some embodiments the control system may generate an alert requesting input from a client device. As stated above, the control system may leverage machine learning to predict solutions. Each solution may have a corresponding probability score. In some embodiments, if the solution with the highest probability score is below a predefined threshold, the control system may alert a user device to confirm whether the solution should be implemented.

Various embodiments of these features will now be discussed with respect to the corresponding figures.

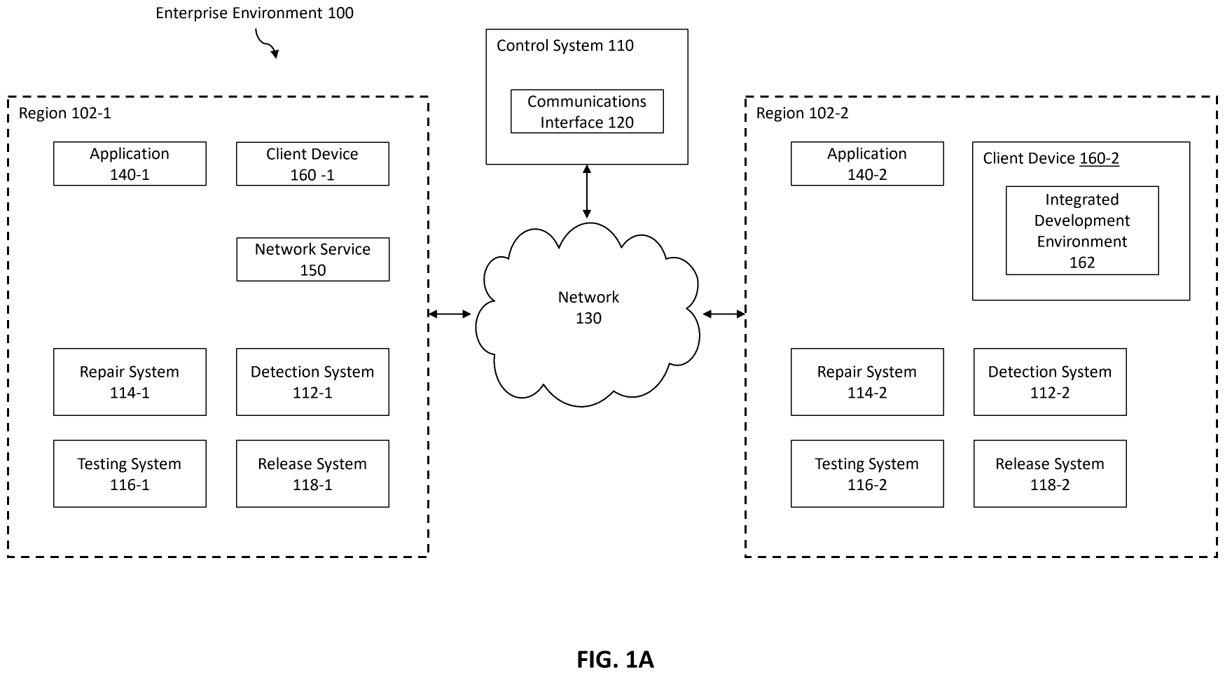

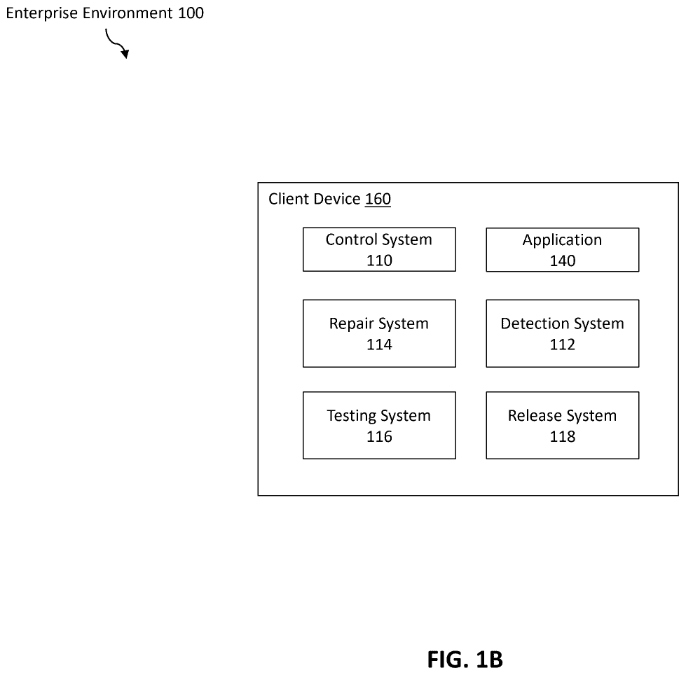

FIG. 1 depicts a block diagram of an enterprise environment 100, according to some embodiments. Enterprise environment 100 includes multiple regions, such as region 102-1 and region 102-2, control system 110, network 130, application 140, network service 150, and client device 160.

Regions may be used to organize or group entities operating within enterprise environment 100. Enterprise environment 100 may include any number of regions. Regions may be defined using logical separation. For example, region 102-1 may be assigned to customers of enterprise environment 100, whereas region 102-2 may be assigned to employees of enterprise environment 100. Regions may further be defined physically. For example, network 130 may include a firewall, router, modem, or other network device to prevent entities within region 102-1 from communicating with entities within region 102-2, and vice versa.

Each region of enterprise environment 100 may include one or more applications 140 and client devices 160. Each region may further include one or more instances of detection system 112, repair system 114, testing system 116, and release system 118. Each region may be associated with one or more applications 140, network service 150, and/or client device 160. Control system 110 may communicate with each region 102, and the entities therein, via network 130.

Network 130 may be any type of computer or telecommunications network capable of communicating data, for example, a local area network, a wide-area network (e.g., the Internet), or any combination thereof. The network may include wired and/or wireless segments. In some embodiments, network 130 may be a secure network.

Application 140 may be any service hosted on network 130. For example, application 140 may be a website, an email service, identity verification service, data storage service, etc. Network 130 may include any number of applications 140. In some embodiments, application 140 may register with control system 110. Registering may allow control system 110 to detect and correct errors at application 140. Application 140 may register with control system 110 by providing control system 110 various information such as a name and process identifier (PID). Application 140 may further provide control system 110 one or more unit tests designed to test application's 140 functionality. In some embodiments, application 140 may provide copies of the unit tests, a location of the unit tests on network 130, or a combination thereof. Application 140 may further provide control system 110 access to application's 140 source code. Similar to the unit tests, application 140 may provide control system 110 a copy of the source code, a location of the source code on network 130, or a combination thereof. As will be discussed below, control system 110 may monitor telemetry values associated with application 140. As part of the registration process, application 140 may indicate which telemetry values control system 110 should monitor, and thresholds corresponding to error states. For example, application 140 may indicate CPU, memory, disk, and network usage as telemetry values. Application 140 may further indicate respective thresholds such as: (1) 80%; (2) 50%; (3) 10 MB/s; and (4) 100 Mbps.

Network service 150 may be any service or application accessible via network 130. Network service 150 may support or provide functionality for application 140. For example, network service 150 may be used to create and verify SSL certificates used for https communications. Network service 150 may be accessible via an API.

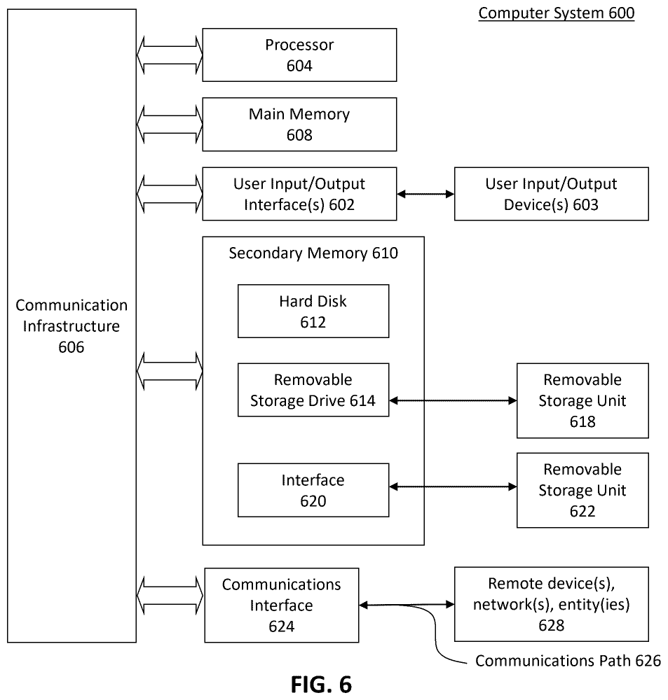

Control system 110 may be implemented using one or more servers and/or databases. In some embodiments, control system 110 may be implemented using a computing device such as a desktop workstation, laptop or notebook computer, netbook, tablet, smart phone, and/or other computing device. In some embodiments, control system 110 may be implemented as an application in an enterprise computing system and/or a cloud-computing system. In some embodiments, control system 110 may be a computer system such as computer system 600 described with reference to FIG. 6. Enterprise environment 100 may include one or more instances of control system 110.

Control system 110 may use communications interface 120 to communicate with application 140, network service 150, and client device 160 via network 130. Communications interface 120 may comprise any suitable network interface capable of transmitting and receiving data, such as, for example a modem, an Ethernet card, a communications port, or the like. Communications interface 120 may be able to transmit data using any wireless transmission standard such as, for example, Wi-Fi, Bluetooth, cellular, or any other suitable wireless transmission. Control system 110 may communicate with entities (e.g., detection system 112, repair system 114, testing system 116, release system 118, network service 150, and client device 160) at each region 102, via network 130.

Detection system 112 may be configured to monitor applications 140 within enterprise environment 100, and identify applications 140 requiring repairs. For example, detection system 112 may identify application 140 has failed (e.g., crashed, stopped responding). Detection system 112 may use various means to determine whether application 140 has crashed. For example, application 140-2 may be executing on a computer (e.g., client device 160-2) and detection system 112 may query the computer's operating system to determine whether application 140-2 is currently executing. Detection system 112 may further determine application 140 has crashed based on a timeout period. As stated above, application 140 may register with control system 110. Part of registration may include initializing a status message between control system 110 and application 140. The status message may be used by detection system 112 to determine whether application 140 is functioning. If detection system 112 fails to receive a status message for a predefined timeout period (e.g., 10 seconds, 1 minute, 5 minutes), detection system 112 may determine application 140 has failed.

Detection system 112 may further identify applications 140 for repair by monitoring telemetry values. Telemetry values may relate to an application's CPU, memory, disk, and network usage. Detection system 112 may reference resource thresholds for each application 140. The thresholds may be defined during application's 140 registration. Each telemetry value (e.g., CPU, memory, disk, and network usage) may have a corresponding threshold. Allowing each application 140 to utilize unique thresholds is beneficial because each application 140 may have different resource needs. For example, a video editing software may use more CPU and memory than a text editor. Therefore, the video editor may have higher telemetry value thresholds than the text editor. As a result, control system 110 will detect fewer false positives with respect based on telemetry values.

Detection system 112 may predict that application 140 has encountered an error when one or more telemetry values passes its corresponding threshold. For example, application 140 may be predicted to have encountered an error if it uses more than 50% of available memory on the machine it's executing.

Detection system 112 may be further configured to monitor log files associated with applications 140 to identify errors. For example, application 140 may generate and write to a log file while operating. Application 140 may be configured to generate log entries for various events such as when application 140 executes, when it terminates, and when it encounters an error. Detection system 112 may monitor logs created by application 140 to detect when an error has occurred.

Detection system 112 may leverage a machine learning model, to determine when application 140 has encountered an error. The model may be trained to correlate data (e.g., telemetry values, status message frequency, log file data) with application's 140 status (e.g., normal operation, failure state). The model at detection system 112 may combine multiple data types to infer application's 140 state. For example, detection system 112 may predict application 140 has encountered an error based on rising telemetry values and an increased status message response time. Although the telemetry values and status message response time may not individually indicate an error at application 140 (e.g., they are below corresponding thresholds), the combination of this data may indicate something is wrong with application 140. Thus, detection system 112 may predict that application 140 has encountered an error.

Detection system 112 may update the machine learning model based on feedback. For example, detection system 112 may have used a set of data (e.g., telemetry values, status message response time) to predict an error. However application 140 may have been functioning normally. Here, detection system 112 may update the model to reflect that those values indicate normal operation.

Applying machine learning to detect errors is beneficial because it will allow control system 110 to become more precise at detecting errors, thereby reducing the number of false positive errors that are reported. In turn, this will reduce: (1) prevent bottlenecks on network 130 resulting from communicating error details; and (2) increase application's 140 operation time.

Detection system 112 may alert repair system 114 when it detects an error at application 140. In some embodiments, detection system 112 may include information regarding the state of application 140 in the alert. For example, if detection system 112 identified an error in application's 140 log, detection system 112 may send the log to repair system 114. In some embodiments, if application 140 crashed or is unresponsive, detection system 112 may send an identifier associated with application 140 (e.g., PID). In some embodiments, detection system 112 may retrieve and send repair system 114 a stack trace associated with application 140.

Repair system 114 may be configured to identify and repair an error associated with application 140. Repair system 114 may use one or more machine learning models to repair the application. The model(s) may be trained to identify error sources and predict repair actions. Repair system 114 may be trained to locate the source of various errors. The model(s) may be trained to learn (e.g., correlate) errors with sources. For example, a model at repair system 114 may be trained to learn that application's 140 failure to compile is most likely associated with a syntax error. As another example, a model at repair system 114 may be trained to learn that a spike in telemetry values (e.g., CPU, memory, disk, or network usage) is most likely associated with application's 140 failure to access a resource on network 130.

In some embodiments, repair system 114 may include one machine learning model for any number of applications 140. For example, a single machine learning model may be trained to identify the source of errors and generate solutions for all connected applications 140. In some embodiments, repair system 114 may include one machine learning model for each application 140. This configuration may be beneficial so that the machine learning model is able to learn exactly how application 140 functions, where errors are likely to occur, and how best to fix them. In some embodiments, repair system 114 may first train a model using data from all applications 140, and then tune the model using data from a specific application 140 that the model will support. This configuration is advantageous because the model will benefit from learning from a wide variety of application 140 data, but then is tailored to a specific application 140.

In some embodiments, repair system 114 may leverage an LLM to perform various tasks. For example, the LLM may be used to read and interpret an application's 140 log file. The LLM may then predict a repair action based on the interpretation. The LLM may be further configured to interpret application's 140 stack trace. The stack trace may include a list of function calls within application 140, and the error that application 140 encountered. The LLM may interpret the stack trace and predict a repair action based on the solution. The LLM may be further configured to analyze application's 140 source code and identify an error within the source code. For example, the LLM may determine that the source code includes a syntax or a logic error. In response, LLM may generate new source code designed to fix the error.

Repair system 114 may be configured to predict various repair actions. For example, repair system 114 may predict that an error occurred based on application's 140 configuration or settings and the solution may include editing application's 140 configuration or settings. For example, application 140 may access a local resource and therefore the file path to the resource may be defined in a configuration file. If the file path does not exist or cannot be reached by application 140 during execution, an error may occur. Here, repair system 114 may locate the resource and write the correct file path to the configuration file.

As another example, application 140 may be configured to access a database on network 130. Application 140 may be configured with a maximum number of database accesses over an amount of time. Setting a maximum number of attempts may be beneficial in an instance where the database cannot be accessed, and therefore application 140 may not become stuck in a loop trying to access the database. However, the database may be a shared resource on network 130, and thus, application 140 may not be able to access the database while other applications 140 are also accessing it. In this example, repair system 114 may predict an action to increase the maximum number of database accesses because the database is a shared resource. Repair system 114 may edit application's 140 configuration or settings file to increase the settings value.

In some embodiments, repair system 114 may predict an action to rewrite application's 140 source code. Repair system 114 may use an LLM to write the source code. In some embodiments, the source code may be added to application's 140 current source code. In some embodiments, repair system 114 may generate source code to overwrite application's 140 current source code. As will be discussed below, the updated application 140 may be tested via testing system 116. Testing system 116 may use one or more unit tests to test application 140. In some embodiments, repair system 114 may be further configured to generate new unit tests, based on the changes to application 140. For example, if repair system 114 uses an LLM to write a new function, the LLM may also generate one or more unit tests to verify that the function works properly.

Repair system 114 may be further configured to document its actions. For example, if repair system 114 uses the LLM to generate new source code, the LLM may further be configured to add comments to the source code describing the functionality. In an instance where application's 140 configuration is updated, repair system 114 may add comments explaining why the update is designed to fix the error.

In some embodiments, repair system 114 may predict a repair action by referencing previous repair actions. For example, repair system 114 may include a store of previously encountered errors and repairs that successfully fixed the errors. Repair system 114 may compare the current error to previous ones, and leverage solutions previously utilized. For example, repair system 114 may use the LLM to generate and store summaries of errors and solutions. Repair system 114 may further store the actual solution in association with the summaries. For example, if repair system 114 used the LLM to generate a new function, then repair system 114 may also use the LLM to create textual summaries of the error and the new function. Subsequently, repair system 114 may store: (1) a summary of the error; (2) a summary of the new function to fix the error; and (3) source code for the new function.

When a new error is encountered, repair system 114 may create summary of the new error. Repair system 114 may then convert the summary to a vector. Repair system 114 may use various algorithms, such as Word2Vec, one-hot encoding, byte pair encoding, and/or integer encoding to create the vector. Repair system 114 may then compare the summary vector to the stored summaries of previously encountered errors. In some embodiments, repair system 114 may convert the stored summaries to vectors. In some embodiments, a vector of the error summary may be created at the time of storage. Repair system 114 may identify a relevant stored summary by computing a vector similarity between the current error vector and the stored error vectors. Repair system 114 may determine a vector similarity by computing cosine similarity, Euclidean distance, dot product similarity, or any other vector similarity measure. Repair system 114 may be further configured to perform a nearest neighbor search to identify a similar vector. Repair system 114 may reference the solution corresponding to the summary with the highest similarity to the encountered error.

For example, application 140-1 may encounter an error because it has attempted to access a database beyond the number of times defined in its configuration file. Previously, application 140-2 may have encountered a similar error, and repair system 114 may have updated application's 140-2 configuration file to increase the maximum number of attempts. Summaries of the previous error, solution, as well as the actual solution (e.g., a copy of the updated configuration file) may be have been stored at repair system 114. Repair system 114 may also have created and stored a vector representation of the error summary. Prior to generating a new solution, repair system 114 may determine whether a previous solution may be utilized. Here, repair system 114 may use the LLM to generate a summary of the current error encountered by application 140-1. The summary may then be converted to a vector. Repair system 114 may then compute the vector similarity between the summary vector, and each stored error summary vector. Repair system 114 may determine that the error previously encountered by application 140-2 is most similar to the current error because it has the highest vector similarity. As a result, repair system 114 may use the solution associated with application 140-2 to repair application 140-1. For example, repair system 114 may determine that because application's 140-2 configuration file was updated, application's 140-1 configuration file should also be updated. Leveraging past solutions will allow control system 110 to become more efficient at generating solutions, while also generating more effective solutions.

Repair system 114 may prioritize or triage errors associated with applications 140. Prioritization or triaging may allow repair system 114 to determine an order in which to repair errors. Repair system 114 may use any prioritization methodology or schema. For example, control system 110 may detect a first error at application 140-1, detect a second error at application 140-2, and repair the second error before the first error. Control system 110 may repair the second error before the first error based on comparing the effects of the errors on the respective applications. Repair system 114 may fix errors causing applications 140 to crash or become unresponsive, before errors causing network delays. For example, an error preventing application 140-1 from executing may be repaired before an error at application 140-2 regarding an outdated setting in a configuration file. In some embodiments, repair system 114 may prioritize certain applications 140 over others. Here, certain applications 140 may be deemed higher priority over others, and thus fixed first, regardless of the error. For example, a banking application 140-1 accessible by customers via network 130 may be fixed, regardless of the error, ahead of an instant messaging application 140-2.

Repair system 114 may predict multiple solutions for a single error. Each solution may have a corresponding probability score based on repair system's 114 confidence that the solution will fix the error. For example, repair system may generate three solutions: (1) update configuration file; (2) update function source code; or (3) restart application. Each solution may have respective probability scores: (1) 80%; (2) 15%; and (3) 5%. Repair system 114 may be configured to implement the solution with the highest probability score. Once repairs system 114 generates and selects a solution, it may send the solution to testing system 116.

Testing system 116 may be configured to test the repaired (e.g., new, updated) version of application 140. In some embodiments, testing system 116 may leverage an isolated environment to perform testing. For example, testing system 116 may include a virtual machine, a sandbox, a container, or a combination thereof, for testing purposes. Testing application 140 in isolation helps to ensure that any remaining or inadvertently introduced errors do not affect other systems on network 130.

Testing system 116 may use a series of unit tests to verify application 140 is functioning properly. Each application 140 may have an associated set of unit tests. Each unit test may be configured to test a part of application 140. For example, application 140 may include one or more functions, and each function may have a corresponding unit test designed to ensure the function works as designed. For example, a unit test for a function may execute the function and compare the output to an expected output (e.g., a predefined value) defined by the unit test. If the output and expected output match, the function passed, otherwise, it failed.

Testing system 116 may be further configured to verify application 140 is functioning properly by executing application 140, and comparing telemetry values of application 140 while executing, to expected telemetry values for application 140. For example, testing system 116 may execute application 140 and collect telemetry values such as CPU, memory, disk, and network usage. Testing system 116 may compare the collected telemetry values to predefined threshold telemetry values. In some embodiments, testing system 116 may average telemetry values for a telemetry category (e.g., CPU usage, RAM usage) prior to making the comparison. In some embodiments, testing system 116 may compare each collected telemetry value to the expected output. For example, testing system 116 may execute application 140, and measure CPU usage ten times. Here, testing system 116 may compare each of the ten measurements to the expected CPU usage for application 140. In some embodiments, testing system 116 may designate application 140 as failing if any of the measured telemetry values exceed the corresponding expected telemetry values. For example, if one of the ten CPU usage measurements exceeds a predefined threshold, testing system 116 may designate application 140 as failing. In some embodiments, testing system 116 may designate application 140 as failing if more than a predefined number of telemetry categories exceeded the expected values. For example, if CPU, memory, and disk usage exceeded their respective values but network usage did not, testing system 116 may designate application 140 as failing. In some embodiments, if CPU, memory, and disk usage remained within their respective thresholds but network usage did not, testing system 116 may designate application 140 as passing.

Testing system 116 may determine application 140 still includes an error. For example, testing system 116 may determine that application 140 has failed a unit test. In response, testing system 116 may alert repair system 114 of the failed unit test so that repair system 114 may generate another solution. As discussed above, repair system 114 may have generated multiple solutions for the single error. In an instance where the selected solution failed to fix the error, repair system 114 may implement one of the other generated solutions. In some embodiments, the implemented solution may have caused or introduced a new error. Here, repair system 114 may generate a new set of solutions to fix the new error.

Testing system 116 may be leveraged to provide feedback to repair system 114 regarding the implemented solution. In some embodiments, testing system 114 may send repair system 114 a label corresponding to the solution's effectiveness. In some embodiments, the label may be binary (e.g., 1, 0), indicating whether the solution fixed the error. This may be determined via unit testing discussed above. In some embodiments, the label may be more granular, based on how effective the solution was at fixing the error. For example, the updated application 140 including repair system's 114 solution may have passed 6/10 unit tests. Here, testing system 116 may provide a label such as 60%, along with the unit tests and their results. Repair system 114 may use the label and results to retrain the machine learning model(s).

In some embodiments, testing system 116 may include feedback from client device 160. For example, client device 160 may be associated with an engineer, administrator, or user of application 140. As will be discussed below, certain updates to application 140 may be staged for inspection by an engineer. This may be beneficial if the change is substantive, in order to ensure the solution has been properly vetted before deployment on network 130. Here, the engineer may make edits or changes to the repair generated by repair system 114 prior to release. Testing system 116 may send the changes to repair system 114. Repair system 114 may save the edits in association with the error. This is beneficial so that repair system 114 can use the error and solution to train and update the machine learning models for improved error correction.

Testing system 116 may determine that application 140 is functioning properly (e.g., application 140 passed all unit tests). Testing system 116 may alert repair system 114 that the solution worked. In response, repair system 114 may store data regarding the error and the solution. This is beneficial so that repair system 114 can update machine learning models based on the repaired error. Additionally, this error and solution may be referenced to fix a future error. Testing system 116 may further alert release system 118.

Release system 118 may be configured to receive an updated application 140 from testing system 116. In some embodiments, release system 118 may increment a version associated with application 140. For example, version 1.0 of application 140 may have encountered an error, and after implementing and testing a solution, release system 118 may increment the version to 2.0 prior to release. Incrementing the version is beneficial to determine the expected state of application 140. For example, once the version is updated, control system 110 may terminate all other instances of application 140 with version numbers different from the updated number. Using the automated process described above improves over prior art systems by detecting, repairing, and deploying solutions in real-time. A prior art system may be shut down for a significant period of time while errors are diagnosed and repaired. Here, any down time is minimized by using control system 110 to detect and repair errors, and then deploy an updated version of the application.

Release system 118 may be configured to interface with a version control system (e.g., git). A version control system may be useful to manage updates to application 140. Release system 118 may interface with a master branch at the version control system. The master branch may correspond to the version of application 140 used in production (e.g., on network 130, on client device 160-2). Release system 118 may further interface with development branches for application 140. A development branch may include changes to application 140 that have not yet been merged into the master branch. For example, a development branch may be used to implement and test a solution. Once it's confirmed the solution works, the development branch may be merged into the master branch.

In some instances, updates to application 140 by repair system 114 may be implemented in their own development branches and subsequently merged into a master branch by release system 118. In some embodiments, release system 118 may stage the updates to application 140 in development branches but not merge them into a master branch. For example, release system 118 may create a new branch of application 140 (e.g., a development branch) including the changes by repair system 114. Release system 118 may then push the development branch onto network 130, so that the branch is accessible. Once pushed, entities on network 130, such as an engineering team associated with client device 160, may pull the development branch to inspect and execute the updated version of application 140. Release system 118 may create a development branch for each error. For example, application 140 may have included a syntax error and a configuration file error. Here, release system 118 may create two development branches, one for the syntax error and the other for the configuration file error.

Release system 118 may determine what action to take based on settings associated with each application 140. For example, an application 140 may have settings dictating that all changes by repair system 114 need to be verified by an engineering team before being merged into a master branch and deployed to enterprise environment 100 by control system 110. A different application 140 may permit changes by repair system 114 to be merged into a master branch and deployed to enterprise environment 100 by control system 110. In some embodiments, release system 118 may stage or deploy updates based on the error that occurred. For example, a repair dealing with a configuration or settings value may be merged into a master branch and deployed to enterprise environment 100, whereas source code changes may be staged within a development branch for further inspection.

Release system 118 may be further configured to stage or notify control system 110 to deploy the updates based on repair system's 114 probability score corresponding to the implemented solution. As previously stated, machine learning models at repair system 114 may predict multiple solutions according to a probability distribution, where each probability corresponds to the model's confidence that the solution will correct the error. Release system 118 may act based on the probability of the implemented solution. For example, for solutions having probability scores greater than 90%, release system 118 may merge with a master branch and notify control system 110 to deploy the solutions. For solutions less than 90%, release system 118 may keep the updates in a development branch. This may be beneficial so that the solution may be inspected by an engineer or developer, to ensure the solution fixed the error. Updated versions of application 140 may be accessed by client device 160

Release system 118 may be further configured to generate alerts regarding updates to application 140. Release system 118 may cause control system 110 to send alerts to client device 160. As stated above, release system 118 may take certain actions based on repair system's 114 confidence. For example, if the solution predicted and implemented by repair system 114 has a corresponding probability greater than or equal to 90%, the alert may include: (1) the branch where updated application 140 is located; and (2) a link to the branch. Additionally, if the probability score is less than 90%, the alert may request input from client device 160 regarding branch management. For example, the alert may request confirmation from client device 160 prior to merging the development with the master branch. This is beneficial to ensure that application 140 is properly managed.

In some embodiments, release system 118 may notify control system 110 that the application 140 is ready for deployment to enterprise environment 100. In response, control system 110 may terminate each instance of application 140, and execute the updated application 140 in their place. In some embodiments, control system 110 may terminate and re-deploy all versions of application 140 in all regions 102. This is beneficial to prevent the error from affecting applications 140 or client devices 160 in other regions 102.

Control system 110 may coordinate and communicate with subsystems in each region 102 using a decentralized consensus algorithm. The decentralized consensus algorithm may be used to manage application(s) 140 within each region. Control system 110 may prioritize certain regions 102 when deploying application 140. Control system 110 may maintain an internal database listing each region 102, and a corresponding priority. Regions 102 with higher priority scores may be provided updated versions of application 140 before regions 102 with lower priority scores. A region 102-1 used by internal employees may have a higher priority, and thus receive an updated application 140 prior to region 102-2 used by external customers that has a lower priority score. As an example, control system 110 may detect an error at a first instance of application 140 deployed at a first region 102-1 and an error at a second instance of application 140 deployed at a second region 102-2. Control system 110 may determine the priority of each region 102 and determine that the first region 102-1 has a higher priority than the second region 102-2. In response, control system 110 may deploy application 140 to region 102-1 before region 102-2.

Control system 110 may be configured to update applications 140 at different regions 102 at different times. For example, control system 110 may stagger updates to each region 102 to have the least impact on operations within region 102. This may be accomplished by control system 110 tracking application 140 usage for each region 102. Control system 110 may predict application 140-1 at region 102-1 will have least usage at a first time, whereas application 140-2 at region 102-2 will have the least usage at a second time. For example, regions 102-1 and 102-2 may be in different time zones, and therefore resources within each respective region 102 may be utilized at different times. Subsequently, control system 110 may update application 140-1 the first time, and then update application 140-2 at region 102-2 at the second time.

Control system 110 may also prioritize certain applications 140 over others. For example, application 140-1 may be an email service and application 140-2 may be an internal web application. Here, repair system 114 may have fixed errors at both applications 140, and notified control system 110 to deploy updated versions. Control system 110 may employ various algorithms to determine an order to deploy updated applications 140.

Control system 110 may deploy updated applications 140 in the order they were fixed. Control system 110 may use a queue to manage the order of applications 140. Release system 118 may place an updated application 140 on the queue, and control system 110 may deploy the next application 140 on the queue (e.g., first in first out). Control system 110 may also use priority scheduling based on the error that was fixed. Control system 110 may maintain an internal mapping of errors and assigned priority levels. Priorities may have varying degrees of granularity. For example, a crash may be high priority, an error associated with communicating with a networked service may be medium priority, and an updated settings value may be low priority. For example, application 140-1 (e.g., email service) that was crashing but is now repaired, may be re-deployed prior to application 140-2 (e.g., web application) that had a settings value changed. Control system 110 may be further configured to deploy applications 140 based on estimated impact on region 102 and/or enterprise environment 100. Here, control system 110 may prioritize applications 140 with the least impact. For example, control system 110 may re-deploy application 140-1 executing in a single region 102-1, before re-deploying application 140-2 executing in five regions 102.

Client device 160 may be any entity utilizing control system 110 and/or application 140. For example, client device 160 may be associated with an administrator or engineer of control system 110. In some embodiments, client device 160 may be associated with a customer of application 140. Client device 160 may be a computer system such as computer system 600 described with reference to FIG. 6. Client device 160 may be a client system such as a desktop workstation, laptop or notebook computer, netbook, tablet, smart phone, and/or other computing device that may be using an enterprise computing system.

In some embodiments, client device 160 may be associated with a developer or engineer and leverage control system 110 to update application 140. For example, client device 160-2 may include integrated development environment (IDE) 162 to edit source code. The source code may correspond to application 140. IDE 162 may establish a connection to and register control system 110 via network 130. The connection and registration may allow control system 110 to access the source code within IDE 162 and make recommendations and/or corrections. Control system 110 may leverage entities within client device's 160-2 region 102-2, such as detection system 112-2 and repair system 114-2, to perform detection and repair. For example, detection system 112-2 may detect an error within the source code at IDE 162, and leverage repair system 114-2 to suggest a reparative action. For example, repair system 114-2 may highlight syntax errors and display suggested corrections.

In some embodiments, client device 160-1 may create and send a version of application 140 to detection system 112-2, prior to deployment. For example, client device 160-1 may use IDE 162 to update application 140. Client device 160-1 may package updated application 140, and send it to detection system 112-2. This may be beneficial so that detection system 112-2 can check application 140 for errors, and determine what actions should be to fix any detected errors.

In this configuration, detection system 112-2 may identify errors and suggest repairs to client device 160-2. In some embodiments, control system 110 may automatically implement the repairs and stage application 140 for release. For example, if repair system 114-2 made a certain number of repairs or edited a certain number of files, application 140 may be staged in a development branch for further testing or inspection. In some embodiments, application 140 may be staged in a development branch based on repair system's 114 confidence thresholds. For example, updated application 140 may be staged in a development branch anytime repair system 114 implemented a solution with a probability score less than 65%. In this example, the model at repair system 114 predicted other solutions may have also fixed the error, therefore it may be beneficial to stage application 140 to allow for further inspection. In some embodiments, control system 110 may identify and fix any errors, merge with a master branch, and then release updated application 140. This may be beneficial for low impact errors, such as those associated with configuration or settings files.

Client device 160 may be further configured to receive alerts from control system 110. Control system 110 may generate and send alerts in response to any of: (1) detecting an error at an application; (2) predicting a solution to fix the error; (3) results of testing the solution; (4) staging the solution for further inspection; (5) merging changes into a master branch; and (6) deploying the updated (e.g., fixed) application.

In some embodiments, client device 160 may respond to the alert. For example, control system 110 may predict multiple solutions, each assigned a probability score. If the highest probability score is less than a predefined threshold, control system 110 may send an alert to client device 160 requesting input. The alert may allow client device 160 to select one of the predicted solutions to implement. For example, control system 110 may detect that application 140 has crashed, and predict three solutions: (1) edit source code at the function where application 140 crashed; (2) edit application's 140 configuration file; and (3) restart application 140. Each solution may have respective probability scores of: (1) 60%; (2) 30%; and (3) 10%. Control system 110 may be configured to alert client device 160 to select a solution when the highest probability score is less than 65%. Here, since the highest probability score (e.g., 60%), is less than the predefined threshold (e.g., 65%), control system 110 may send the alert including the solutions to client device 160. In response, client device 160 may interact with the alert to send a response to control system 110. The response may include a selected solution. For example, client device 160 may interact with the alert and send a message including a selection of the first solution to edit the source code. In response, control system 110 may be configured to implement the selected solution.

FIG. 1B depicts a block diagram of client device 160 with an integrated control system 110, according to some embodiments. In some embodiments, client device 160 (may include instances of control system 110 detection system 112, repair system 114, testing system 116, release system 118, and application 140 (e.g., application 140-2). In this configuration, client device 160 may leverage control system 110 to identify, predict, and implement repairs locally. For example, client device 160 may be a server hosting application 140. Application 140 may be available to other client devices 160 via network 130. Here, control system 110 may monitor application 140 for errors and perform local repairs. This may be beneficial so that less data is communicated over network 130. For example, if network 130 encounters an error, application 140 can still be repaired locally by control system 110. Additionally, this configuration may be beneficial to improve computer security. Client device 160 may be deployed within a secure environment where data access and communications are tightly controlled. In this configuration, it is still desirable to leverage control system 110 to monitor and repair application 140. Therefore, control system 110 may be deployed onto client device 160 to locally detect and fix repairs at application 140. This configuration improves computer security since data relating to application's 140 errors and predicted repairs does not have to be sent over network 130.

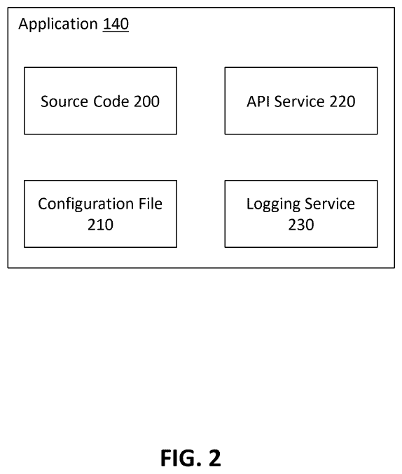

FIG. 2 depicts a block diagram of application 140, according to some embodiments. Application 140 includes source code 200, configuration file 210, API service 220, and logging service 230. Source code 200 may be the software that implements the functionality of application 140. Source code 200 may be represented in one or more programming languages such as C, C++, Java, Python, C#, or Javascript, or a combination thereof. Source code 200 may include libraries implemented in different languages. As stated above, control system 110 may be configured to detect and repair errors associated with application 140. Errors may result from syntax and logic errors. When detected, control system 110 may leverage an LLM to create new source code 200 designed to fix the error.

Configuration file 210 may be used to store settings associated with application 140. The settings may relate to application's 140 functionality. For example, configuration file 210 may be used to store URLs of external services accessed by application 140 (e.g., URL of network service 150) and file paths to local resources (e.g., log file locations). Configuration file 210 may be further configured to define telemetry values, and corresponding thresholds for error detection. Repair system 114 may update configuration file 210 by adding new settings or editing existing settings. For example, application 140 may encounter an error because a variable referenced by application 140 does not exist in configuration file 210. Here, repair system 114 may edit configuration file 210 to add the referenced variable.

API service 220 may be used to communicate with services, such as network service 150, on network 130. For example, application 140 may have an accompanying SSL certificate. API service 220 may communicate with network service 150 to obtain or update the SSL certificate. In some embodiments, API service 220 may update configuration file 210. Using the example above, API service 220 may update the path to the retrieved SSL certificate at configuration file 210.

Logging service 230 may be configured to generate logs related to application 140. Logs created by logging service 230 may be written to files. The location of the files may be defined in configuration file 210. Logs may relate to the operation of application 140 and includes various pieces of information. For example, logging service 230 may write a log entry when application 140 is started, when an error is encountered, and when application 140 terminates. Each log entry may include a date time field and a description of the event causing the log entry to be written. Each log entry may be assigned a category or priority. For example, a log entry for an error may be assigned a higher category than a log entry for when application 140 is started.

In some embodiments, all logs, regardless of entry category, may be written to the same log file. In some embodiments, each log category may be written to a separate file. This may be beneficial so that application's 140 status is rapidly determined. Configuration file 210 may include a setting to determine which categories of logs to generate. For example, a first application's 140 configuration file 210 may include a setting to log all categories of information, whereas a second application's 140 configuration file 210 may include a setting to only log errors.

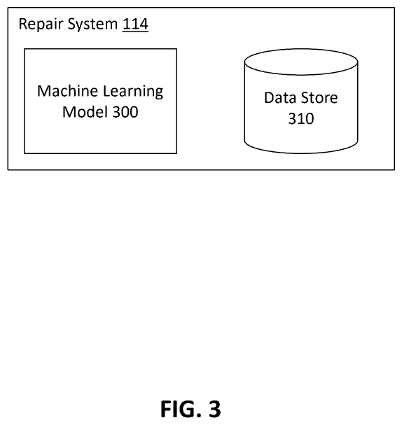

FIG. 3 depicts a block diagram of repair system 114, according to some embodiments. Repair system 114 includes machine learning model 300 and data store 310. Machine learning model 300 may be a machine learning model using any architecture or design. In some embodiments, machine learning model 300 may be a large language model built utilizing a transformer architecture. In some embodiments, repair system 114 may include multiple machine learning models 300. Here, each model 300 may correspond to a different application 140. This may be beneficial so that each model 300 is tailored to precisely identify and fix errors associated with its assigned application 140. In some embodiments, machine learning model 300 may be a single model configured to diagnose and repair errors at any application 140. This configuration will result in a more robust model 300, capable of handling a multitude of errors from various applications 140.

Machine learning model 300 may be trained to predict solutions for detected errors at application 140. For errors relating to configuration files, machine learning model 300 may be trained to resolve resource file paths and update them. For errors relating to third-party services, machine learning model 300 may be trained to interact with the third-party service. Machine learning model 300 may be further configured to solve errors relating to telemetry values. For example, machine learning model may correlate telemetry values, with certain errors that are solved by certain solutions. For example, machine learning model 300 may be trained to detect that a spike in network usage may be associated with application's 140 inability to access a network resource. In response, machine learning model 300 may determine where the network resource exists, and update a path that application 140 is using to access the resource.

For errors relating to source code, machine learning model 300 may be trained to edit and generate new source code. Machine leaning model 300 may be trained to edit and produce source code by: (1) inputting source code; and (2) predicting the next line of the source code. Based on the prediction, machine learning model 300 may be updated. For example, if machine learning model 300 predicted the correct next line, a set of weights associated with the input source code and the prediction may be updated. If machine learning model 300 was incorrect, a set of weight associated with the input source code and the correct prediction may be updated. This process may similarly apply for individual words or punctuation so that machine learning model 300 may a language's syntax. For example, machine learning model 300 may input a line of source code, and predict punctuation that should come at the end of the line.

Machine learning model 300 may be trained on source code from any programming language such as C, C++, Java, Python, C#, or Javascript. Machine learning model 300 may include internal representation (e.g., a set of weights) for each programming language. Machine learning model 300 may train using data at data store 310.

Data store 310 may be implemented on a memory device. Data store 310 may be configured to store data for use by machine learning model 300. Data store 310 may be organized in any fashion. For example, data store 310 may be organized into key value pairings, where each key corresponds to an error and each value is a solution to fix the error. In some embodiments, key-value pairs may be stored under application 140 they correspond to. For example, a first application 140 may have associated with it, a first set of key-value pairs, whereas a second application 140 may have a second set of key-value pairs. This configuration is beneficial so that model 300 is able to learn solutions tailored to each application 140. In some embodiments, data store 310 may be organized by error type. For example, all syntax errors and solutions, regardless of which application 140 they correspond to, may be grouped together. Additionally, errors associated with application 140 configuration or settings may be in another group.

Data store 310 may be configured to store vector representations of errors. As stated above, repair system 114 may identify previously encountered errors that are similar to the current one. Repair system 114 may locate similar previous errors by computing a vector similarity between a summary vector of the current error and summary vectors of previous errors. Therefore, each time an error and corresponding solution is added to data store 310, a vector representation of the summary of the error may also be added. Machine learning model 300 may be used to generate the summary of the error. A tokenization algorithm, such as word2vec or byte pair encoding may be used to convert the summary to a vector representation.

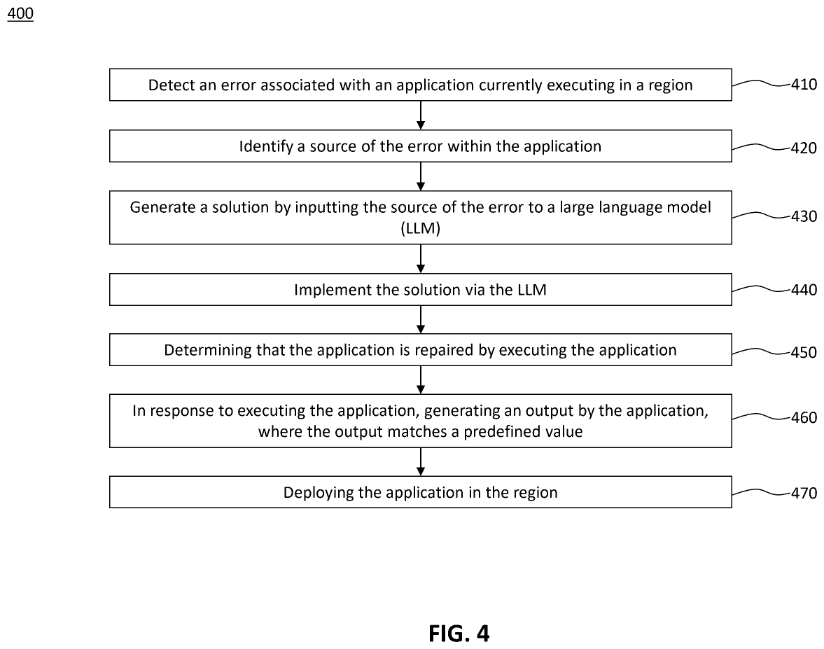

FIG. 4 depicts a flowchart illustrating a method 400 for using artificial intelligence (AI) to perform self-healing on software systems, according to some embodiments. Method 400 shall be described with reference to FIG. 1, however, method 400 is not limited to that example embodiment.

In an embodiment, control system 110 may utilize method 400 to identify and repair software-based errors. Once the error is fixed, the software may be redeployed to the environment. The foregoing description will describe an embodiment of the execution of method 400 with respect to control system 110. While method 400 is described with reference to control system 110, method 400 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4.

At 410, control system 110 detects an error associated with an application currently executing in a region. The region may be region 102 and the application may be application 140. Control system 110 may use detection system 112 to perform the detection. Detection system 112 may detect the error using various methods. Detection system 112 may query an operating system of the machine where application 140 is executing. Detection system 112 may detect that the applications telemetry values exceed predefined thresholds. Detection system 112 may further detect an error based on a status message timeout. In some embodiments, detection system 112 may determine an error based on messages written to the application's log files.

At 420, control system 110 identifies a source of the error within application 140. Control system 110 may use repair system 114 to identify the source of the error. For example, repair system 114 may be trained to learn that application's 140 failure to compile is most likely associated with a syntax error. As another example, a model at repair system 114 may be trained to learn that a spike in telemetry values (e.g., CPU, memory, disk, or network usage) is most likely associated with application's 140 failure to access a resource on network 130. Additionally, repair system 114 may be trained to interpret a log file generated by application 140. For example, repair system 114 may use an LLM to interpret the log file and identify what component of application caused the error to be written to the log file. Similarly, repair system 114 may use an LLM to interpret a stack trace from application 140, and determine the part of application 140 that failed.

At 430, control system 110 generates a solution by inputting the source of the error to a large language model. The large language model may be part of machine learning model 300 at repair system 114. If the error is associated with source code, application's 140 source code may be input to the LLM. For example, at 420, repair system 114 may have analyzed a stack trace, and determined that an exception occurred at Function A within application 140. Therefore, at 430, application's 140 source code, including Function A, may be input to the LLM. As stated above, the LLM (e.g., machine learning model 300) may be trained to analyze source code, determine whether an error is present, and if so, generate a solution. The solution may be new source code. If the error is related to application's 140 configuration, the LLM may generate a new configuration file or edit a current configuration file. The LLM may be configured to generate multiple solutions, each having a probability corresponding to the LLM's confidence that the corresponding solution is correct.

At 440, control system 110 implements the solution via the LLM. For example, the LLM may generate new source code to fix the error at the application. Control system 110 may replace the source code at application 140 with the source code created by the LLM. Control system 110 may implement the solution with the highest probability. In some embodiments, control system 110 may implement a solution with a probability score greater than a predefined threshold. For example, control system 110 may only implement a solution with a corresponding probability score greater than or equal to 80%. This is beneficial to help ensure that the error will in fact be fixed.

At 450, control system 110 determines that the application is repaired by executing the application. Control system 110 may use testing system 116 to make the determination. In some embodiments, control system 110 may first recompile the application to generate a new executable. Control system 110 may then run the executable as a new instance of the application. If application 140 built using an interpreted language (e.g., Python) control system 110 may execute application 140 without having to compile it. In some embodiments, control system 110 may execute the application in a sandboxed environment (e.g., virtual machine, sandbox, container) that is inaccessible via network 130. This is beneficial to ensure that if the application still includes an error, the error does not affect operations on network 130.

At 460, the application generates an output, where the output matches a predefined value. For example, control system 110 may execute a unit test at the application. The unit test may be configured to test a function at the application, to ensure it is working properly. In some embodiments, the entire application may be tested, regardless of the error that was detected and fixed. In some embodiments, a subset of the application's functionality related to the error may be tested. In some embodiments, the LLM described above (e.g., machine learning model 300) may have created new unit tests along with the new source code.

At 470, control system 110 deploys the application in the region. The region may be region 102 within enterprise environment 100. In some embodiments, control system 110 may replace each instance of the application currently executing. For example, two versions of the application may be executing, one at a first region 102 and one at a second region 102. Control system 110 may deploy the application on both regions 102 to ensure that the most up to date, error free version of the application is executing. In some embodiments, control system 110 may interface with a version control system (e.g., git) as part of the deployment. For example, control system 110 may merge the updated version of the application into a master branch at the version control system. In some embodiments, control system 110 may create and deploy the updated version of the application on a development branch. This may be beneficial to allow for further testing of the updated application.

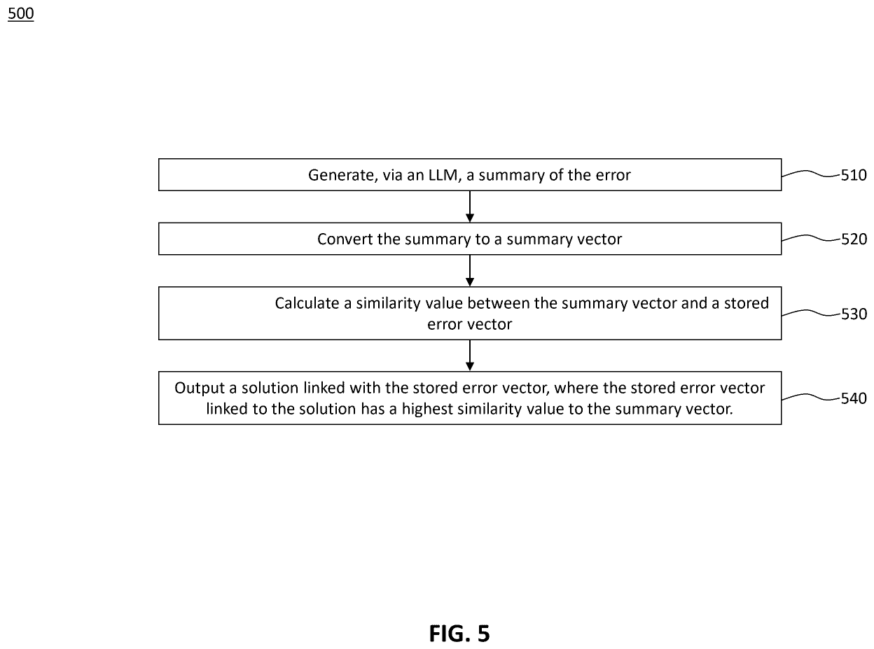

FIG. 5 depicts a flowchart illustrating a method 500 for using an LLM to fix a software error, according to some embodiments. Method 500 may include additional details related to 430 as described with reference to method 400. Method 500 shall be described with reference to FIG. 1; however, method 500 is not limited to that example embodiment.

In an embodiment, control system 110 may utilize method 500 identify and use solutions to previous errors that are similar to a current error. The foregoing description will describe an embodiment of the execution of method 500 with respect to control system 110 and/or method 500. While method 500 is described with reference to control system 110, method 500 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5.

At 510, control system 110 generates, via an LLM, a summary of the error. The LLM may be machine learning model 300 at repair system 114. As stated above, machine learning model 300 may be configured to analyze software, detect errors, and generate solutions. Here, machine learning model 300 may be configured to generate a text-based summary of the error. The summary is beneficial because it may be communicated in-real to other entities on network 130. For example, control system 110 may communicate the summary to client device 160 associated with an administrator of the application. This is an improvement over prior art systems that require manual intervention to diagnose the error. By automatically detecting, diagnosing, and summarizing the failure, this data can be communicated in real-time to provide application's 140 status.

At 520, control system 110 converts the summary to a summary vector. The summary vector may be a numerical representation of the text-based summary. Control system 110 may transform the summary using various algorithms, such as Word2Vec, one-hot encoding, and/or integer encoding. The summary vector may be generated such that the meaning of the text-based summary is maintained. For example, similar words (e.g., lake and ocean) may have more similar vector values than dissimilar words (e.g., lake and school).

At 530, control system 110 calculates a similarity value between the summary vector and a stored error vector. The stored error vector may be the vector representation of a summary of an error previously encountered and fixed by control system 110. As stated above, control system 110 may save errors and their solutions. Control system 110 may save text-based summaries of the error and the solution, as well as the actual solution (e.g., the new source code, the new configuration file). Here, control system 110 may calculate a similarity value in order to identify a previous error that is most similar to the current error.

In some embodiments, the stored error vector may be stored at data store 310. Control system 110 may compute the similarity by applying one or more similarity algorithms. For example, cosine similarity, Euclidean distance, or dot product similarity may be used. In some embodiments, control system 110 may use a nearest neighbor search to identify the most similar vector at data store 310. Both the summary vector and the stored error vectors in data store 310 may have certain dimensions. In some embodiments, the dimensions of the summary vectors and the vectors in data store 310 may be different. In some embodiments, the dimensions of the summary vectors and the vectors in data store 310 may be the same.

At 540, control system 110 outputs a solution linked with the stored error vector, wherein the stored error vector linked to the solution has a highest similarity value to the summary vector. The solution may have previously been implemented by control system 110 to repair the stored error. The solution may be used by control system 110 to fix the current error. In some embodiments, control system 110 may send the solution to client device 160. For example, control system 110 may use an LLM to create a text-based summary of the solution, and send the summary to client device 160.

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (e.g., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method for autonomous software repair, the method comprising:
detecting a first error associated with an application executing in a region;
repairing the first error associated with the application comprising:
identifying a source of the first error within the application;
generating a solution by inputting the source of the first error to a large language model (LLM); and
implementing the solution via the LLM; and
determining that the application is repaired by:
executing the application;
generating, by the application, an output; and
comparing the output to a predefined value; and
deploying the application in the region in response to determining that the application is repaired.

2. The computer implemented method of claim 1, wherein identifying the source of the first error comprises identifying an error message within a log file associated with the application.

3. The computer implemented method of claim 1, wherein identifying the source of the first error comprises determining a telemetry value associated with the application is greater than a predefined threshold.

4. The computer implemented method of claim 1, wherein the first error is associated with source code of the application and generating the solution further comprises generating new source code by the LLM, wherein the new source code is designed to repair the first error.

5. The computer implemented method of claim 1, wherein the first error is associated with a configuration value of the application and implementing the solution further comprises updating the configuration value.

6. The computer implemented method of claim 1, wherein generating the solution further comprises:
generating, by the LLM, a summary of the first error;
converting the summary to a summary vector;
calculating a similarity value between the summary vector and a stored error vector; and
outputting the solution linked with the stored error vector, wherein the stored error vector linked to the solution has a highest similarity value to the summary vector.

7. The computer implemented method of claim 1, further comprising:
detecting a second error associated with a second instance of the application executing in a second region;
determining the first region has a higher priority than the second region; and
in response to the determination, deploying the application to the first region prior to the second region.

8. The computer implemented method of claim 1, further comprising:
detecting a second error associated with the application; and
repairing the second error before the first error, based on a comparison of an effect of the first error and an effect of the second error on the application.

9. The computer implemented method of claim 1, wherein the predefined value is at least one of: (i) an expected output defined by a function unit test, (ii) CPU usage, (iii) memory usage, or (iv) network usage.

10. A system, comprising:
a memory; and
at least one processor coupled to the memory and configured to:
detect a first error associated with an application executing in a region;
repair the first error associated with the application comprising:
identifying a source of the first error within the application;
generating a solution by inputting the source of the first error to a large language model (LLM); and
implementing the solution via the LLM; and
determine that the application is repaired by:
executing the application;
generating an output; and
comparing the output to a predefined value; and
deploy the application in the region in response to determining that the application is repaired.

11. The system of claim 10, wherein identifying the source of the first error comprises identifying an error message within a log file associated with the application.

12. The system of claim 10, wherein identifying the source of the first error comprises determining a telemetry value associated with the application is greater than a predefined threshold.

13. The system of claim 10, wherein the first error is associated with source code of the application and generating the solution further comprises generating new source code by the LLM, wherein the new source code is designed to repair the first error.

14. The system of claim 10, wherein the first error is associated with a configuration value of the application and implementing the solution further comprises updating the configuration value.

15. The system of claim 10, wherein generating the solution further comprises:
generating, by the LLM, a summary of the first error;
converting the summary to a summary vector;
calculating a similarity value between the summary vector and a stored error vector; and
outputting the solution linked with the stored error vector, wherein the stored error vector linked to the solution has a highest similarity value to the summary vector.

16. The system of claim 10, further comprising:
detecting a second error associated with the application; and
repairing the second error before the first error, based on a comparison of an effect of the first error and an effect of the second error on the application.

17. A non-transitory computer-readable device having instructions stored thereon that, when executed by at least one computing device, cause the at least one computing device to perform operations comprising:
detecting a first error associated with an application executing in a region;
repairing the first error associated with the application comprising:
identifying a source of the first error within the application;
generating a solution by inputting the source of the first error to a large language model (LLM); and
implementing the solution via the LLM; and
determining that the application is repaired by:
executing the application;
generating an output; and
comparing the output to a predefined value; and
deploying the application in the region in response to determining that the application is repaired.

18. The non-transitory computer-readable device of claim 17, wherein the first error is associated with source code of the application and generating the solution further comprises generating new source code by the LLM, wherein the new source code is designed to repair the first error.

19. The non-transitory computer-readable device of claim 17, wherein identifying the source of the first error comprises determining a telemetry value associated with the application is greater than a predefined threshold.

20. The non-transitory computer-readable device of claim 17, wherein generating the solution further comprises:
generating, by the LLM, a summary of the first error;
converting the summary to a summary vector;
calculating a similarity value between the summary vector and a stored error vector; and
outputting the solution linked with the stored error vector, wherein the stored error vector linked to the solution has a highest similarity value to the summary vector.
